(19) United States
(12) Patent Application Publication
(10) Pub. No.: US 2025/0342556 A1
(43) Pub. Date: Nov. 6, 2025

(54) VIDEO DATA PROCESSING METHOD, APPARATUS, DEVICE, STORAGE MEDIUM AND EDGE DEVICE

(71) Applicants: Beijing BOE Technology Development Co., Ltd., Beijing (CN); BOE Technology Group Co., Ltd., Beijing (CN)

(72) Inventor: Pu YUAN, Beijing (CN)

(21) Appl. No.: 18/996,304

(22) PCT Filed: Apr. 16, 2024
(86) PCT No.: PCT/CN2024/088029

§ 371 Date: Jan. 17, 2025

(30) Foreign Application Priority Data
May 30, 2023 (CN) 202310626368.8

(51) Int. Cl. G06T 1/20; H04N 21/44; H04N 21/845

(52) U.S. Cl. CPC G06T 1/20; H04N 21/44016; H04N 21/8456

(57) ABSTRACT

A video data processing method, a device, a storage medium and an edge device are provided, which relate to artificial intelligence, in particular to computer vision and edge computing. The method includes: obtaining a plurality of first tensor data based on a plurality of video frame data, where the first tensor data includes a plurality of sub-tensor data each corresponding to a respective one of a plurality of deep learning models; splicing the plurality of sub-tensor data in the first tensor data to obtain a plurality of second tensor data each corresponding to a respective one of the plurality of deep learning models; and allocating the plurality of second tensor data to a plurality of graphics processing units in a graphics processor, based on the deep learning models respectively deployed by the graphics processing units, such that the graphics processor performs data inference on the plurality of second tensor data.

### TECHNICAL FIELD

The present disclosure relates to the field of artificial intelligence technology, in particular to the field of computer vision and edge computing technology, and specifically to a video data processing method and apparatus, a device, a storage medium and an edge device.

### BACKGROUND

In edge computing, calculations of applications, data and services may be moved from a central node of the network to a logic edge node of the network for processing. For example, in the scenario of video surveillance analysis, edge computing may be like that an electronic device deployed on the edge node processes the video data collected by a plurality of cameras connected to the edge node.

### SUMMARY

The present disclosure provides a video data processing method and apparatus, a device, a storage medium and an edge device.

According to an aspect of the present disclosure, a video data processing method is provided, including: obtaining a plurality of first tensor data based on a plurality of video frame data received within a preset time window, where the plurality of first tensor data includes a plurality of sub-tensor data each corresponding to a respective one of a plurality of deep learning models; splicing the plurality of sub-tensor data in the plurality of first tensor data to obtain a plurality of second tensor data each corresponding to a respective one of the plurality of deep learning models; and allocating the plurality of second tensor data to a plurality of graphics processing units in a graphics processor, based on the deep learning models respectively deployed by the plurality of graphics processing units, such that the graphics processor performs data inference on the plurality of second tensor data.

According to another aspect of the present disclosure, a video data processing apparatus is provided, including: a first processing module configured to: obtain a plurality of first tensor data based on a plurality of video frame data received within a preset time window, where the plurality of first tensor data includes a plurality of sub-tensor data each corresponding to a respective one of a plurality of deep learning models; a second processing module configured to: splice the plurality of sub-tensor data in the plurality of first tensor data to obtain a plurality of second tensor data each corresponding to a respective one of the plurality of deep learning models; and an allocation module configured to: allocate the plurality of second tensor data to a plurality of graphics processing units in a graphics processor, based on the deep learning models respectively deployed by the plurality of graphics processing units, such that the graphics processor performs data inference on the plurality of second tensor data.

According to yet another aspect of the present disclosure, an electronic device is provided, including a memory and a processor, where the memory stores instructions executable by the processor, and the instructions, when executed by the processor, cause the processor to perform the method described above.

According to yet another aspect of the present disclosure, a non-transitory computer-readable storage medium is provided, which stores computer instructions configured to cause a computer to perform the method described above.

According to yet another aspect of the present disclosure, a computer program product is provided, including a computer program which, when executed by a processor, implements the method described above.

According to yet another aspect of the present disclosure, an edge device is provided, including: a service plug-in manager, an inference manager and a model manager. The service plug-in manager is configured to: obtain a plurality of first tensor data based on a plurality of video frame data received within a preset time window, where the plurality of first tensor data includes a plurality of sub-tensor data each corresponding to a respective one of a plurality of deep learning models. The inference manager is configured to: splice the plurality of sub-tensor data in the plurality of first tensor data to obtain a plurality of second tensor data each corresponding to a respective one of the plurality of deep learning models; and allocate the plurality of second tensor data to a plurality of graphics processing units in a graphics processor based on the deep learning models respectively deployed by the plurality of graphics processing units. The model manager is configured to: perform data inference on the plurality of second tensor data using the graphics processor.

It should be understood that the content described in this section is not intended to identify key or important features of the embodiments of the present disclosure, nor is it intended to limit the scope of the present disclosure. Other features of the present disclosure will become intelligible from the following description.

### BRIEF DESCRIPTION OF THE DRAWINGS

The accompanying drawings are used to better understand the present disclosure and do not constitute a limitation of the present disclosure.

FIG. 1 schematically shows a schematic diagram of a video data processing method in the related art.

FIG. 2 schematically shows an exemplary system architecture to which a video data processing method is applicable according to the embodiments of the present disclosure.

FIG. 3 schematically shows a flowchart of a video data processing method according to the embodiments of the present disclosure.

FIG. 4 schematically shows a schematic diagram of a video data processing method according to the embodiments of the present disclosure.

FIG. 5 schematically shows a schematic diagram of an edge device according to the embodiments of the present disclosure.

FIG. 6A schematically shows a schematic diagram of a frame multiplexer according to the embodiments of the present disclosure.

FIG. 6B schematically shows a schematic diagram of a workflow of reusing a video frame by a frame multiplexer according to the embodiments of the present disclosure.

FIG. 7 schematically shows a schematic diagram of a service plug-in manager according to the embodiments of the present disclosure.

FIG. 8 schematically shows a schematic diagram of a communication process between a service plug-in manager and an inference manager according to the embodiments of the present disclosure.

FIG. 9 schematically shows a schematic diagram of a model manager according to the embodiments of the present disclosure.

FIG. 10 schematically shows a block diagram of a video processing apparatus according to the embodiments of the present disclosure.

FIG. 11 schematically shows a block diagram of an electronic device suitable for implementing a video data processing method according to the embodiments of the present disclosure.

### DETAILED DESCRIPTION OF EMBODIMENTS

In order to make the objectives, technical solutions and advantages of the embodiments of the present disclosure apparent, the technical solutions of the embodiments of the present disclosure will be clearly and completely described below in conjunction with the drawings of the embodiments of the present disclosure. Obviously, the described embodiments are only part of the embodiments of the present disclosure, rather than all the embodiments. Based on the described embodiments of the present disclosure, all other embodiments obtained by those of ordinary skill in the art without inventive labor are within the scope of protection of the present disclosure. It should be noted that throughout the drawings, the same elements are represented by the same or similar reference numerals. In the following description, some specific embodiments are only used for description and should not be understood as any limitation to the present disclosure, but are merely examples of the embodiments of the present disclosure. Conventional structures or configurations will be omitted when they may cause confusion in the understanding of the present disclosure. It should be noted that shapes and sizes of the components in the drawings do not reflect actual sizes and proportions, but merely illustrate the contents of the embodiments of the present disclosure.

Unless otherwise defined, technical or scientific terms used in the present disclosure should have the common meanings understood by those skilled in the art. The terms “first”, “second” and the like used in the present disclosure do not indicate any order, quantity or importance, but are only used to distinguish different components.

In the embodiments of the present disclosure, the collection, updating, analysis, processing, use, transmission, provision, disclosure, storage and other aspects of the data (for example, including but not limited to a user personal information) involved all comply with the provisions of relevant laws and regulations, are used for legal purposes, and do not violate public order and good morals. In particular, necessary measures are taken to prevent illegal access to user personal information data and to maintain the security of user personal information, network security and national security.

In the embodiments of the present disclosure, the user's authorization or consent is obtained before the user's personal information is obtained or collected.

With the development of Internet technology, the centralized processing mode of cloud computing has gradually failed to meet the real-time requirements of service processing. In this regard, services with high real-time requirements may be deployed on edge nodes, so that the edge nodes complete the processing operations of the service to achieve rapid response of the service. For example, in a video surveillance analysis scenario, the server device deployed at an edge node may be used to process various collected videos at the edge node.

However, in the related technology, for each video frame data in the various collected videos, a separate service processing module is generally used to process the video frame data, and when the service processing module processes the video frame data, it needs to apply for additional computing resources of the graphics processing unit (GPU) to process an inference request. For example, as shown in Table 1, the inference request may include metadata “Meta” and data “Data”. The metadata “Meta” may include the name of a deep learning model involved, such as yolov5, and the input interface standard of the deep learning model, such as 684,684,3, which means that the data input to the deep learning model should be a 3-channel 684×684 image data. The metadata “Meta” may be an explanation of the data “Data”. The data “Data” may be represented as a video frame data, for example, 108,255,0,88 in Table 1 may be represented as a part of the video frame data.

TABLE 1

| | | |
|---|---|---|
| Meta | yolov5 | 684,684,3 |

| | |
|---|---|
| Data | 108,255,0,88, . . . |

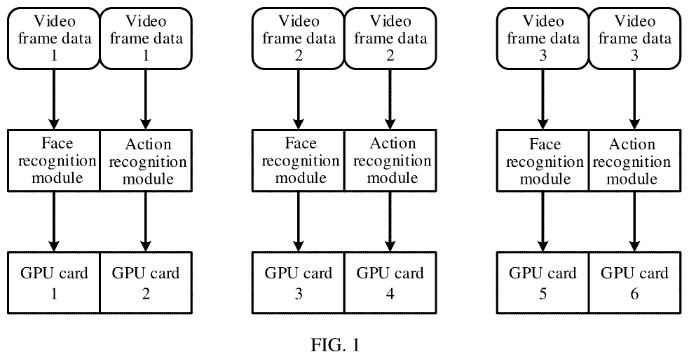

FIG. 1 schematically shows a schematic diagram of a video data processing method in the related art.

As shown in FIG. 1, a plurality of service processing modules may be deployed in an electronic device, such as a face recognition module, a forbidden area recognition module, an action recognition module, etc. Before processing the video frame data, each of the plurality of service processing modules needs to decode the collected video to obtain the video frame data. After the service processing modules complete the pre-processing of the video frame data, it may assign the pre-processed video frame data to the computing module of the electronic device, and use computing resources of the computing module to complete the processing of the video frame data. The computing module may include a plurality of GPU cards, such as a GPU card 1, a GPU card 2, etc. The functions implemented by the service processing module generally require a plurality of deep learning models to implement, and the deep learning models required by the respective service processing modules may be different from each other. Therefore, each of the plurality of GPU cards needs to be deployed with a full-scale deep learning models.

Therefore, in the related art, taking the number of service processing modules as M and the total number of deep learning modules as P as an example, to complete the processing of N video frame data, M×N decoding operations are required and N×M×P deep learning models are required to be deployed in the computing module. Therefore, implementing video data processing requires a significant amount of computing and storage resources, which imposes high demands on the performance of the electronic device, making it difficult to deploy the electronic device at the edge.

In view of this, embodiments of the present disclosure provide a video data processing method, by which the usage of computing resources may be effectively reduced, the utilization rate of a graphics processor may be improved, and the device applying the video data processing method may be deployed at the edge terminal. Specifically, the method includes: obtaining a plurality of first tensor data based on a plurality of video frame data received within a preset time window, where the plurality of first tensor data includes a plurality of sub-tensor data each corresponding to a respective one of a plurality of deep learning models; splicing the plurality of sub-tensor data in the plurality of first tensor data to obtain a plurality of second tensor data each corresponding to a respective one of the plurality of deep learning models; and allocating the plurality of second tensor data to a plurality of graphics processing units in a graphics processor, based on the deep learning models respectively deployed by the plurality of graphics processing units, such that the graphics processor performs data inference on the plurality of second tensor data.

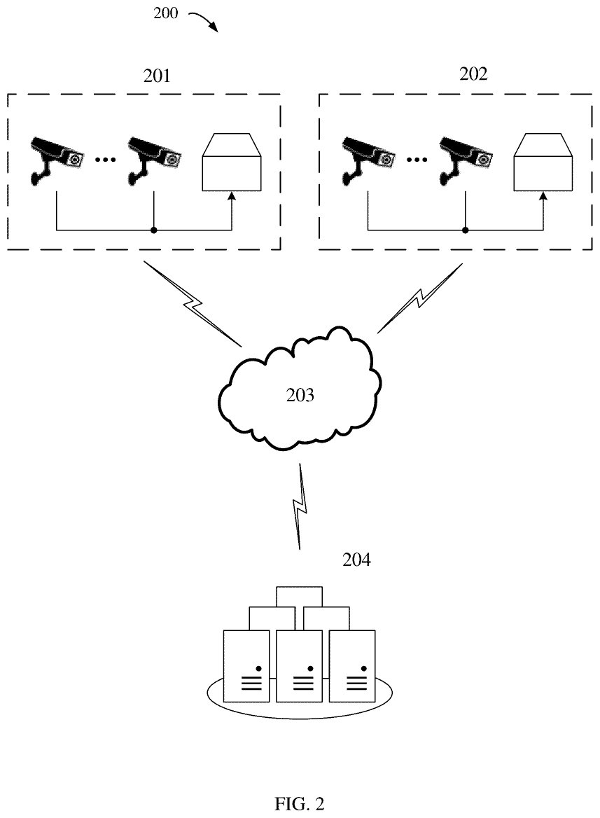

FIG. 2 schematically shows an exemplary system architecture to which a video data processing method is applicable according to the embodiments of the present disclosure. It should be noted that FIG. 2 is only an example of a system architecture to which the embodiments of the present disclosure may be applied, for facilitating those skilled in the art in understanding the technical content of the present disclosure, but it does not mean that the embodiments of the present disclosure cannot be used in other devices, systems, environments or scenarios.

As shown in FIG. 2, the system architecture 200 according to the embodiments may include edge clusters 201 and 202, a network 203 and a computing center 204.

The edge clusters 201 and 202 may include edge devices and one or more camera devices, the one or more camera devices may be used to acquire video streams, and the edge device may be used to process the video streams acquired by the one or more camera devices. The edge devices may be various electronic devices, including but not limited to smart phones, tablet computers, laptop computers, and desktop computers.

The network 203 is used to provide a medium for a communication link among the edge cluster 201, the edge cluster 202 and the computing center 204. The network 203 may include various connection types, such as wired and/or wireless communication links. The network 203 may be further configured with a gateway and a firewall for access control among the edge cluster 201, the edge cluster 202 and the computing center 204.

The computing center 204 may include various types of server devices. The server device may be a GPU server, which may be used to provide computing and storage resources for edge devices of the edge clusters 201 and 202.

It will be noted that, generally, the video data processing method provided in the embodiments of the present disclosure may be executed by the computing center 204. Accordingly, the video data processing apparatus provided in the embodiments of the present disclosure may be provided in the computing center 204.

For example, the camera device in the edge clusters 201 and 202 may record a video, and a recorded video stream may be transmitted to the computing center 204 in real time by the edge devices in the edge clusters 201 and 202. The computing center 204 may decode the video stream to obtain a plurality of video frame data, convert the plurality of video frame data, and splice them based on dimensions of deep learning models to obtain a plurality of second tensor data. The plurality of second tensor data may be allocated based on resource consumption of a GPU card of each of the plurality of servers deployed in the computing center 204, so as to process the second tensor data using the GPU cards, thereby realizing the processing of the plurality of video frame data.

Alternatively, the video data processing method provided in the embodiments of the present disclosure may be performed by the edge devices in the edge clusters 201 and 202, and accordingly, the apparatus provided in the embodiments of the present disclosure may be provided in the edge devices in the edge clusters 201 and 202.

It will be understood that the numbers of the edge clusters, the computing center and the network in FIG. 2 are only schematic. According to the implementation requirements, there may be any number of edge cluster(s), computing center(s) and network(s).

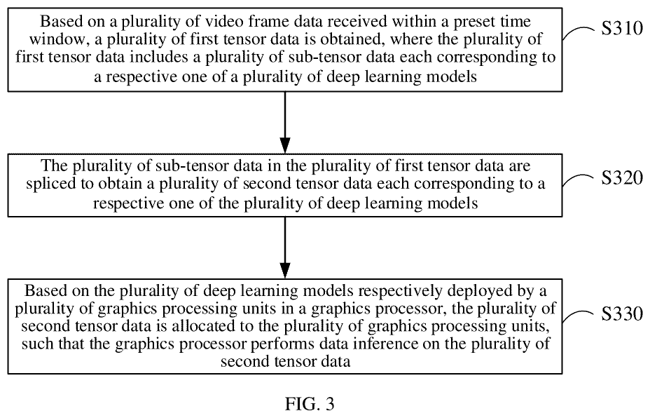

FIG. 3 schematically shows a flowchart of a video data processing method according to the embodiments of the present disclosure.

As shown in FIG. 3, the video data processing method may include operations S310 to S330.

In operation S310, based on a plurality of video frame data received within a preset time window, a plurality of first tensor data is obtained, where the plurality of first tensor data includes a plurality of sub-tensor data each corresponding to a respective one of a plurality of deep learning models.

In operation S320, the plurality of sub-tensor data in the plurality of first tensor data is spliced to obtain a plurality of second tensor data each corresponding to a respective one of the plurality of deep learning models.

In operation S330, based on the deep learning models respectively deployed by a plurality of graphics processing units in the graphics processor, the plurality of second tensor data is allocated to the plurality of graphics processing units, such that the graphics processor performs data inference on the plurality of second tensor data.

According to the embodiments of the present disclosure, the preset time window may be represented as a time period with a preset duration, and a window size of the preset time window is the preset duration. The preset duration and a step size of the preset time window may be set based on the specific application scenario, for example, the preset duration may be set to be equal to the step size of the preset time window to avoid a repeated processing on video frame data, which is not limited here.

According to the embodiments of the present disclosure, the plurality of video frame data may include video frame data from different video streams. For example, a video frame data 1 may be one of a plurality of video frame data obtained by decoding a video stream a collected by a device A, and a video frame data 2 may be one of a plurality of video frame data obtained by decoding a video stream b collected by a device B.

According to the embodiments of the present disclosure, for each video frame data, the video frame data may be processed based on input requirements of the plurality of deep learning models, so as to obtain a plurality of sub-tensor data. Each sub-tensor data may be represented as a matrix. For example, the deep learning model may be an image recognition model that processes RGB images, and the sub-tensor data corresponding to the deep learning model may be represented as a 3×H×W matrix, where 3 represents the value of a channel dimension, H may represent the height of an RGB image, and W may represent the width of the RGB image. For another example, the received video frame may be a grayscale image, and accordingly, a video frame data thereof may be represented as a 1×H×W matrix. A deep learning model A may be a model for processing a grayscale image, and the video frame data may be directly used as a sub-tensor data adapted to the input of the deep learning model A. A deep learning model B may be a model for processing an RGB image. During the generation of a sub-tensor data adapted to the input of the deep learning model B, a color domain conversion may be performed on the video frame data to convert a value of each pixel in the video frame data from a grayscale value to an RGB value, so as to achieve the conversion from the grayscale color domain to the RGB color domain, thereby obtaining a sub-tensor data represented as a 3×H×W matrix.

According to the embodiments of the present disclosure, a plurality of sub-tensor data may be spliced to obtain a first tensor data. During the splicing, missing dimensional data in the plurality of sub-tensor data may be filled, and the sub-tensor data may be spliced based on an additional dimension. For example, a sub-tensor data A may be represented as a 3×H1×W1 matrix, a sub-tensor data B may be represented as a 1×H2×W2 matrix, where H1 is greater than H2, and W2 is greater than W1. The sub-tensor data A and the sub-tensor data B may be filled respectively, and each of the filled sub-tensor data A and the filled sub-tensor data B may be represented as a 3×H1×W2 matrix. After the filled sub-tensor data A and the filled sub-tensor data B are spliced, a first tensor data obtained may be represented as a 2×3×H1×W2 matrix.

According to the embodiments of the present disclosure, a video data processing method may be used to implement various service functions, and each service function may be implemented using one or more of the plurality of deep learning models. For each service function, each video frame data may be processed based on the input requirements of the one or more deep learning models required to implement the service function to obtain one or more sub-tensor data, and the one or more sub-tensor data may be spliced to obtain a first tensor data. That is, the plurality of first tensor data may include a plurality of first tensor data belonging to different service functions, and a first tensor data corresponding to each service function may include one or more sub-tensor data corresponding to the one or more deep learning models. In an example that the number of video frame data is N and the number of types of service functions is 2, the implementation of a first service function requires the support of P1 deep learning models, and the implementation of a second service function requires the support of P2 deep learning models. Based on the N video frame data, 2×N first tensor data may be obtained. Each of the N first tensor data corresponding to the first service function may include P1 sub-tensor data, and each of the N first tensor data corresponding to the second service function may include P2 sub-tensor data.

According to the embodiments of the present disclosure, the plurality of sub-tensor data in the plurality of first tensor data is spliced, and the plurality of sub-tensor data in the respective first tensor data may be classified based on a deep learning model dimension. Each sub-tensor data may carry a model label, and the deep learning model associated with this sub-tensor data may be determined through the model label, thereby completing the classification of the sub-tensor data. More than one sub-tensor data in each category may be suitable for processing by a single deep learning model. The more than one sub-tensor data in each category may be spliced to obtain a second tensor data. That is, the second tensor data obtained after the classification may be processed using a single deep learning model.

According to the embodiments of the present disclosure, the graphics processor may include a plurality of image processing units, each image processing unit may be represented as a GPU card, and the plurality of second tensor data may be allocated to a plurality of GPU cards for processing. One or more deep learning models may be deployed in each GPU card. After receiving a second tensor data, the GPU card may use the corresponding deep learning model deployed in the GPU card to process the second tensor data, so as to obtain a processing result of the second tensor data.

According to the embodiments of the present disclosure, the method of allocating the plurality of second tensor data to the plurality of image processing units may include but is not limited to: average allocation, low-fragmentation allocation and the like. The average allocation may be an allocation method in which the loads of the plurality of GPU cards are substantially equal after the allocation. The low-fragmentation allocation may be an allocation method which prioritizes using a non-idle GPU card for data processing.

According to the embodiments of the present disclosure, each sub-tensor data in the second tensor data may carry a video frame label. Through the video frame label, the video frame data associated with the sub-tensor data may be determined, so that the processing result of the video frame data may be determined based on the processing result of the second tensor data.

According to the embodiments of the present disclosure, all the video frame data received within the time window may be converted into a plurality of first tensor data. Each first tensor data may include a plurality of sub-tensor data, which may be processed and obtained based on the input requirements of the corresponding deep learning model. The plurality of sub-tensor data in the plurality of first tensor data may be spliced to obtain a plurality of second tensor data. When data processing is performed, tasks of the plurality of second tensor data may be allocated in the image processor based on a load balancing strategy to complete the processing of the video frame data. By splicing sub-tensor data corresponding to a same deep learning model into a second tensor data, a data batch size may be increased, so that the batch processing capability of the graphics processor may be effectively utilized, the throughput of the graphics processor may be increased, and the utilization rate of the graphics processor may be improved. Furthermore, it is possible to reduce the number of the deep learning models required to be deployed in the memory of the graphics processor and thus reduce the resource consumption of the graphics processor, so that a small edge device may achieve the processing of the video data.

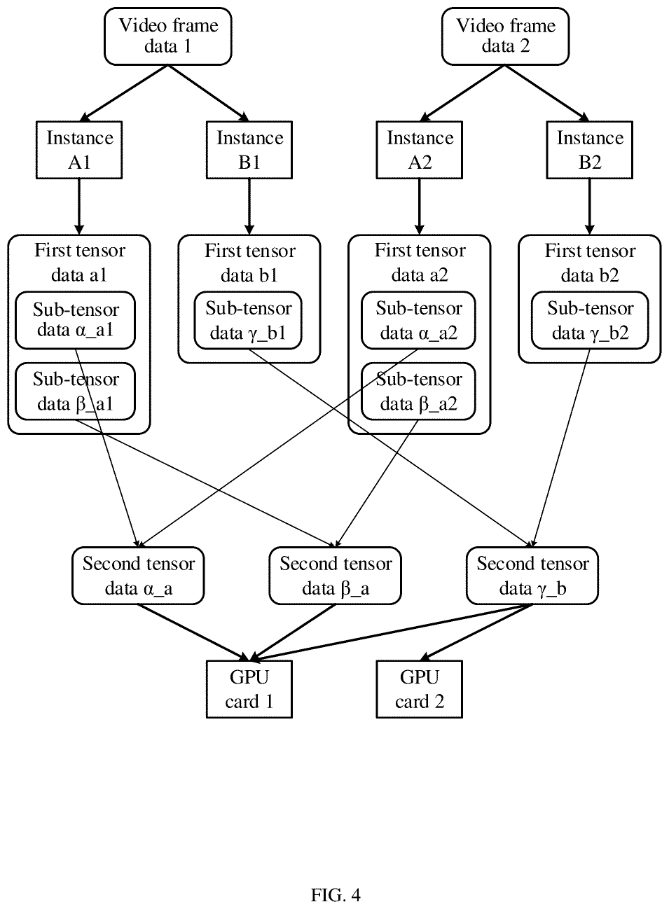

The video data processing method shown in FIG. 3 will be further described below with reference to FIG. 4 in combination with specific embodiments.

According to the embodiments of the present disclosure, in response to receiving a video stream, the video stream is decoded to obtain video frame data.

According to the embodiments of the present disclosure, the video stream may be collected and encoded by a camera device. The video stream may be represented as a segment of video, and accordingly, the video frame data is obtained by decoding the segment of video. There may be a plurality of camera devices, and accordingly, there may be a plurality of video streams. The plurality of video frame data may include video frame data obtained by respectively decoding the plurality of video streams.

According to the embodiments of the present disclosure, for each of the plurality of video frame data received within the preset time window, the video frame data may be converted into at least one first tensor data based on at least one loaded dynamic link library. Based on the at least one first tensor data converted from each of the plurality of video frame data, a plurality of first tensor data is obtained.

According to the embodiments of the present disclosure, the dynamic link library may be represented as a decoupled library file, such as a file with a “.so” suffix on Linux. The dynamic link library may support various service interface methods, and the service interface methods may include init (initialization), stop, start, pause, resume, etc. In an initialization phase, the dynamic link library may be loaded onto the memory. Through the loading of the dynamic link library onto the memory of the device, various service interface methods may be used to implement the call of a service function represented by the dynamic link library.

According to the embodiments of the present disclosure, the dynamic link library may be associated with at least one target deep learning model, which may be from the plurality of deep learning models. Specifically, in the dynamic link library, at least one target deep learning model may be called to implement a service function represented by the dynamic link library.

According to the embodiments of the present disclosure, converting the video frame data into the first tensor data may be converting the video frame data based on an input interface standard of each of the plurality of deep learning models to obtain at least one first tensor data. Specifically, for each video frame data, based on at least one loaded dynamic link library, converting the video frame data into at least one first tensor data may include the following operations.

For each of the plurality of video frame data received within the preset time window, based on the at least one dynamic link library, at least one service instance is generated; the at least one service instance is run, where the at least one service instance is configured to load the video frame data, and the video frame data is processed based on an input interface standard of the at least one target deep learning model associated with the service instance, and at least one sub-tensor data is obtained; and at least one first tensor data is obtained based on the at least one sub-tensor data corresponding to each of the at least one service instance.

According to the embodiments of the present disclosure, the service instance may be represented as a task, and by executing the service instance, a service function corresponding to the dynamic link library may be realized. Accordingly, generating the service instance based on the dynamic link library may be creating a new task based on requirements described in the dynamic link library.

According to the embodiments of the present disclosure, in an example of the deep learning model being an image processing model, the input interface standard of the image processing model may indicate that the input data is single-channel grayscale image data. The video frame data to be processed may be three-channel RGB image data. The video frame data may be processed based on an input interface standard of the image processing model, and a color space conversion may be performed on the video frame data to be processed, and an RGB value of each pixel in the video frame data may be converted into a grayscale value, so as to obtain the video frame data to be processed, i.e. the sub-tensor data corresponding to the image processing model.

According to the embodiments of the present disclosure, the video data processing is completed based on the dynamic link library, so as to achieve the decoupling between the service function and the service process. Based on this, when facing new service function requirements, the developer may write the new service function requirements into a separate dynamic link library based on a template, and then write the dynamic link library into the memory, thereby realizing the launch of the new service function. As such, the efficiency of service development may be effectively improved.

According to the embodiments of the present disclosure, the decoded video frame data may be temporarily stored to facilitate reuse of the video frame data by at least one service instance. Specifically, in response to receiving the video frame data, the video frame data may be written into a storage unit. After at least one service instance is generated and started up, the service instance may load the video frame data from the storage unit.

According to the embodiments of the present disclosure, the storage unit may refer to a memory, a hard disk, a database or other storage device, which is not limited here.

According to the embodiments of the present disclosure, the reuse of the video frame data by the at least one service instance may be achieved using a reference counter. Specifically, after the video frame data is written into the storage unit, a data packet may be obtained, in which the video frame data may be stored in a packet body part of the data packet, and a header part of the data packet may record fields associated with the video frame data. A count field of the video frame data may be configured based on the number of the at least one dynamic link library, and the count field may be the reference counter. For example, the count field may be added to a field of the packet body part of the data packet corresponding to the video frame data, or the count field may be added to the header part of the data packet corresponding to the video frame data. In response to detecting that the service instance loads the video frame data from the storage unit, the value of the count field of the video frame data may be updated. When the value of the count field of the video frame data reaches a preset value, the video frame data is released from the storage unit.

According to the embodiments of the present disclosure, the value of the updated count field of the video frame data may be increased or decreased by the data update step. For example, the data update step may be set to 1, and the value of the count field of the updated video frame data may be a value of the previous count field minus 1.

According to the embodiments of the present disclosure, the preset value may be set based on a specific application scenario, for example, the preset value may be set to 0. When the value of the count field of the video frame data reaches the preset value, it may indicate that the video frame data has been called for a predetermined number of times.

According to the embodiments of the present disclosure, the releasing of the video frame data from the storage unit may include deleting the video frame data from the storage unit physically.

According to the embodiments of the present disclosure, configuring the count field of the video frame data may include adding a count field for the video frame data, where the count field may be represented as a parameter with a value of null. The initial value of the count field may be determined based on the number of the at least one dynamic link library. Specifically, the initial value of the count field may be determined based on the data update step, the total number of the dynamic link libraries, and the preset value. For example, in a case that the number of dynamic link libraries is a, the data update step is b, and the preset value is c, the initial value of the count field may be determined to be (c+a×b).

For example, after receiving the decoded video frame data, the video frame data may be packaged into a data packet. The data packet may be written into the memory, a field ref_counter may be added to the data packet, and the initial value of the field ref_counter may be set based on the number of the generated service instances. If the number of the generated service instances is 3, the initial value of the field ref_counter may be set to 3. After the service instance is started up, a thread of the service processor may be used to run one service instance. A smart pointer may be configured in each thread to point to the data packet in the memory. Alternatively, a smart pointer may be configured in the service processor, and the service instance in each thread of the service processor may call the smart pointer configured in the service processor. After the service instance is started up, the service instance may determine an address of the data packet in the memory by calling the smart pointer, thereby realizing loading of the data packet. After the service instance loads the data packet to reuse the video frame data, the value of the field ref_counter may be controlled to be reduced by 1. When the value of the field ref_counter reaches 0, the data packet in the memory may be released to destroy the corresponding video frame data.

According to the embodiments of the present disclosure, by storing the video frame data in the storage unit, at least one service instance may reuse the video frame data through a pointer. By adding the reference counter for the video frame data, when the service instance uses the video frame data through a pointer, the value of the reference counter may change accordingly, and when the value of the reference counter reaches a preset value, the video frame data may be released. In this way, the reuse of video frame data may be realized, and each service instance does not need to repeatedly decode the video stream when using the video frame data, so that it is possible to reduce the number of decoding operations and saving computing resources. In addition, the storage unit does not need to store the video frame data generated during a repeated decoding process, thereby saving storage resources.

According to the embodiments of the present disclosure, at least one first tensor data may be generated for each video frame data using at least one service instance, and the plurality of first tensor data may include the at least one first tensor data of each of the plurality of video frame data. Specifically, the at least one first tensor data associated with each of the plurality of video frame data may be combined to obtain a plurality of first tensor data.

According to the embodiments of the present disclosure, the preset time window may include a plurality of sub-windows, and in each sub-window, one or more first tensor data output by all the completed service instances may be packaged into a request, the request may be packaged into a message, and one or more first tensor data may be used as the message body data of the message. The request is sent to a management module of the graphics processor, so that the management module may perform resource scheduling to fully leverage the large-batch data processing capability of the graphics processor.

According to the embodiments of the present disclosure, the plurality of sub-tensor data in each first tensor data may correspond to different deep learning models respectively. With deep learning models as dimensions, the sub-tensor data corresponding to the deep learning model in the plurality of first tensor data may be classified into one category. All sub-tensor data in each category may be combined to obtain a large-size and high-dimensional second tensor data. The management module of the image processor may perform resource scheduling for the large-size, high-dimensional second tensor data. In the related art, each received video frame data has to be packaged into a message which is then sent to the management module of the graphics processor, thus the management module has to schedule each video frame data separately. Since after the data to be processed is received, the graphics processor needs to generate a respective processing task for each of the deployed deep learning models, and given that the graphics processor has a strong large-batch data processing capability, the processing time and the resource occupation of each processing task are poorly correlated with a data size of the data to be processed. That is, in each processing task, the time and resources consumed in processing a small-sized single video frame data and in a large-sized and high-dimensional second tensor data is substantially the same. In contrast, the method, in which a plurality of first tensor data is spliced to obtain a plurality of second tensor data and then resources are scheduled for the plurality of second tensor data, may fully leverage the large-batch data processing capability of the graphics processor.

According to the embodiments of the present disclosure, the allocation of a plurality of second tensor data, by the management module of the graphics processor, to the plurality of graphics processing units based on the deep learning models respectively deployed by the plurality of graphics processing units in the graphics processor may include the following operations.

For each second tensor data, based on a deep learning model corresponding to the second tensor data and the deep learning models respectively deployed by the plurality of graphics processing units, at least one target graphics processing unit is determined from the plurality of graphics processing units, where at least one deep learning model deployed by the at least one target graphics processing unit includes the deep learning model corresponding to the second tensor data. The second tensor data is allocated to the at least one target graphics processing unit.

According to the embodiments of the present disclosure, for example, a GPU A, a GPU B and a GPU C may each be deployed with a model a, and when a second tensor data associated with the model a is allocated, the GPU A, the GPU B and the GPU C may be the at least one target GPU determined. Accordingly, the second tensor data associated with the model a may be allocated to the GPU A, the GPU B and the GPU C for processing.

According to the embodiments of the present disclosure, allocating the second tensor data to the at least one target graphics processing unit may include the following operations.

Based on a resource margin of the at least one target graphics processing unit, the second tensor data is segmented with the sub-tensor data as a granularity to obtain at least one sub-data. The at least one sub-data is allocated to at least one target graphics processing unit.

According to the embodiments of the present disclosure, when the second tensor data is segmented with the sub-tensor data as the granularity, the sub-tensor data may serve as the minimum unit of the segmentation. That is, sub-tensor data in each of the second tensor data after the segmentation is/are all complete, and each sub-data may include one or more sub-tensor data.

For example, at least one target graphics processing unit includes a graphics processing unit A, a graphics processing unit B, a graphics processing unit C, and a graphics processing unit D. Resource margins of the graphics processing unit A, the graphics processing unit B, the graphics processing unit C and the graphics processing unit D are 70%, 80%, 100% and 50%, respectively. The second tensor data may include 100 sub-tensor data. The processing capabilities of graphics processing unit A, the graphics processing unit B, the graphics processing unit C and the graphics processing unit D may be the same, and the processing of each sub-tensor data requires 1% of the resources of the graphics processing unit.

In the case that the second tensor data is split based on the balanced allocation strategy, the second tensor data may be split into 3 sub-data, namely a sub-data a, a sub-data b and a sub-data c, the sub-data a may include 20 sub-tensor data, the sub-data b may include 30 sub-tensor data, and sub-data c may include 50 sub-tensor data. The sub-data a may be allocated to the graphics processing unit A for processing, the sub-data b may be allocated to the graphics processing unit B for processing, the sub-data c may be allocated to the graphics processing unit C for processing, and the graphics processing unit D is not allocated. After the data allocation is completed, the resource margins of the graphics processing unit A, the graphics processing unit B, the graphics processing unit C and the graphics processing unit D are all 50%, so that the loads of the graphics processing units may be substantially equal.

In the case that the second tensor data is split based on the anti-fragmentation allocation strategy, the second tensor data may be split into 2 sub-data, namely a sub-data d and a sub-data e respectively, and each of the sub-data d and the sub-data e may include 50 sub-tensor data. The sub-data d may be allocated to the graphics processing unit D, the sub-data e may be allocated to the graphics processing unit A, and no sub-data is allocated to the graphics processing unit B and the graphics processing unit C. After completing the data allocation, the resource margin of the graphics processing unit A is 20%, the resource margin of the graphics processing unit B is 80%, the resource margin of the graphics processing unit C is 100%, and the resource margin of the graphics processing unit D is 0%, thereby ensuring the completion of the resources of the graphics processing units. When a large-batch data is received, the graphics processing units with complete resources may be used to process the large-batch data, thereby improving the data inference efficiency of the image processing units.

FIG. 4 schematically shows a schematic diagram of a video data processing method according to the embodiments of the present disclosure.

As shown in FIG. 4, the video data processing method may decode a video stream from cameras configured in various service systems to obtain a video frame data. The various service systems may include, for example, an access control system, a confidential area management system, a road violation detection system, etc. Taking the access control system as an example, the access control system may be a system for recognizing and verifying identities of people entering and leaving various parks. The camera configured in the access control system may be used to obtain information such as portraits and identity credentials. Accordingly, the decoded video frame data may be image data including the information such as portraits and identity credentials. By using the video data processing method in the embodiments of the present disclosure to process videos obtained by the access control system, video frame data respectively obtained by the plurality of cameras may be processed in parallel to improve the processing efficiency of the video frame data.

According to the embodiments of the present disclosure, the video frame data received within the preset time window may include a video frame data video1 and a video frame data video2.

According to the embodiments of the present disclosure, service functions required by the access control system may include a face recognition function and a forbidden area management function. Accordingly, for each video frame data, two service instances respectively corresponding to the face recognition function and the forbidden area management function may be generated. Specifically, an instance A1 and an instance B1 corresponding to the video frame data video1 may be generated, and an instance A2 and an instance B2 corresponding to the video frame data video2 may be generated.

According to the embodiments of the present disclosure, each instance may process a corresponding video frame data based on a deep learning model required to realize a corresponding service function to obtain the first tensor data. For example, the face recognition function is achieved using the model α and the model β, and the forbidden area management function is achieved using the model γ. Accordingly, the instance A1 processes the video frame data video1 to obtain a first tensor data a1, which may include a sub-tensor data α_a1 determined based on an input interface standard of the model α and a sub-tensor data β_a1 determined based on an input interface standard of the model β. The instance A2 processes the video frame data video2 to obtain a first tensor data a2, which may include a sub-tensor data α_a2 determined based on the input interface standard of the model α and a sub-tensor data β_a2 determined based on the input interface standard of the model β. The instance B1 processes the video frame data video1 to obtain a first tensor data b1, which may include a sub-tensor data γ_b1 determined based on an input interface standard of the model γ. The instance B2 processes the video frame data video2 to obtain a first tensor data b2, which may include a sub-tensor data γ_b2 determined based on the model γ.

According to the embodiments of the present disclosure, the sub-tensor data may be aggregated and spliced based on the dimensions of the deep learning models to obtain the second tensor data. Specifically, the sub-tensor data α_a1 and the sub-tensor data α_a2 may be spliced to obtain a second tensor data α_a, the sub-tensor data β_a1 and the sub-tensor data β_a2 may be spliced to obtain a second tensor data β_a, and the sub-tensor data γ_b1 and the sub-tensor data γ_b2 may be spliced to obtain a second tensor data γ_b.

According to the embodiments of the present disclosure, a graphics processor may include a GPU card 1 and a GPU card 2, and the model α, the model β and the model γ may be deployed in the GPU card 1, and the model γ may be deployed in the GPU card 2. Therefore, the target graphics processing unit corresponding to the second tensor data α_a is the GPU card 1, the target graphics processing unit corresponding to the second tensor data β_a is the GPU card 1, and the target graphics processing units corresponding to the second tensor data γ_b are the GPU card 1 and the GPU card 2.

According to the embodiments of the present disclosure, when the second tensor data is allocated, the second tensor data α_a and the second tensor data β_a may be allocated to the GPU card 1. Based on the resource margins of the GPU card 1 and the GPU card 2, the second tensor data γ_b may be split into two sub-data, and the two sub-data may be allocated to the GPU card 1 and the GPU card 2 respectively.

According to the embodiments of the present disclosure, the video data processing method as described above may be implemented by an edge device.

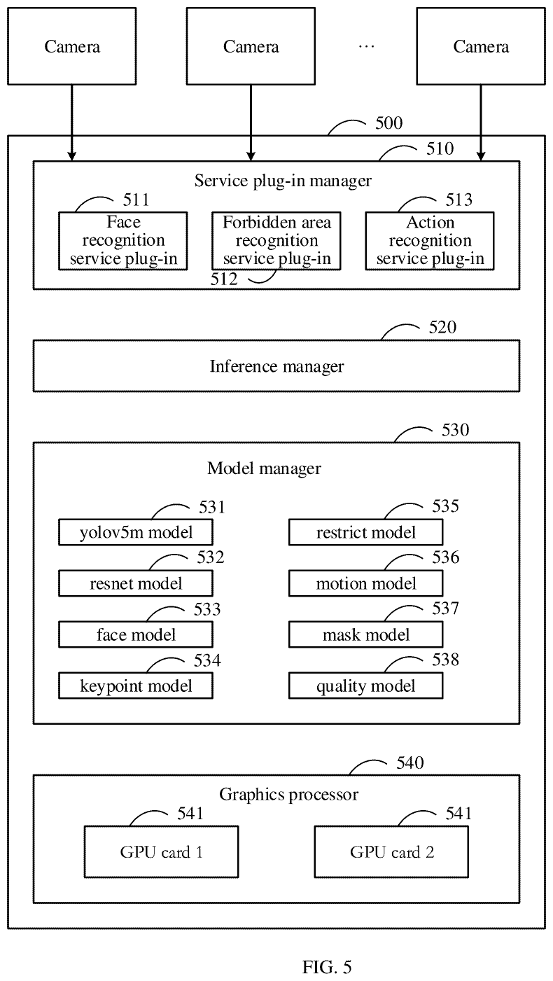

FIG. 5 schematically shows a schematic diagram of an edge device according to the embodiments of the present disclosure.

As shown in FIG. 5, the edge device 500 may include a service plug-in manager 510, an inference manager 520, and a model manager 530. The edge device 500 may be represented as a single electronic device, such as a GPU server. Alternatively, the edge device 500 may include a plurality of electronic devices, such as a plurality of GPU servers, the service plug-in manager 510 may be deployed on one or more GPU servers, and the inference manager 520 and the model manager 530 may be deployed on another GPU server.

According to the embodiments of the present disclosure, the service plug-in manager 510 may connect a plurality of cameras through external interfaces of the edge device. For a video stream generated by each camera, the service plug-in manager 510 may be configured to decode the video stream in response to receiving the video stream, so as to obtain video frame data.

According to the embodiments of the present disclosure, the service plug-in manager 510 may be configured to: obtain a plurality of first tensor data based on a plurality of video frame data received within a preset time window. The first tensor data includes a plurality of sub-tensor data each corresponding to a respective one of the plurality of deep learning models.

According to the embodiments of the present disclosure, the inference manager 520 may be configured to: splice the plurality of sub-tensor data in the plurality of first tensor data to obtain a plurality of second tensor data each corresponding to a respective one of the plurality of deep learning models.

According to the embodiments of the present disclosure, the service plug-in manager 510 may be configured with a plurality of service plug-ins. For example, the service plug-in manager 510 may include a face recognition service plug-in 511, a forbidden area recognition service plug-in 512, an action recognition service plug-in 513, etc. The service plug-in may be represented as a dynamic link library written into a memory.

According to the embodiments of the present disclosure, the inference manager 520 may be configured to: allocate the plurality of second tensor data to a plurality of graphics processing units in the graphics processor, based on the plurality of deep learning models deployed by the plurality of graphics processing units.

According to the embodiments of the present disclosure, the model manager 530 may be configured to: perform data inference on the plurality of second tensor data using the graphics processor.

According to the embodiments of the present disclosure, the model manager 530 may be used to manage the deep learning models required to be deployed in the image processor. The deep learning models may include, for example, a yolov5m model 531, a resnet model 532, a face model 533, a keypoint model 534, a restrict model 535, a motion model 536, a mask model 537, a quality module 538, etc. The combination of one or more of the above deep learning models may be used to implement different service functions. For example, the face recognition function in the access control system may be implemented by the resnet model 532 and the face model 533. The number of deep learning models that the model manager may manage may be set based on specific application scenarios, which is not limited here.

According to the embodiments of the present disclosure, the model manager 530 may further be used to manage a plurality of graphics processing units 541 in the graphics processor 540, such as a GPU card 1, a GPU card 2, etc.

According to the embodiments of the present disclosure, one or more deep learning models may be pre-deployed in each graphics processing unit 541. For example, the yolov5m model 531, the resnet model 532 and the keypoint model 534 may be deployed in the GPU card 1, and a resnet model 532, a motion model 536 and a mask model 537 may be deployed in the GPU card 1. The model manager 530 may be used to maintain a mapping table including a mapping relationship between a graphics processing unit 541 and a deep learning model, i.e. the deep learning model required to be deployed in the graphics processing unit 541. After the edge device 500 starts working, the model manager 530 may deploy a respective deep learning model in each graphics processing unit 541 based on the mapping table.

According to the embodiments of the present disclosure, when allocating a second tensor data, the inference manager 520 may allocate the second tensor data to a corresponding graphics processing unit based on the deep learning model corresponding to the second tensor data. For example, if the deep learning model corresponding to the second tensor data A is the yolov5m model 541, the inference manager 520 may allocate the second tensor data A to the GPU card 1. For another example, if the deep learning model corresponding to the second tensor data B is the resnet model 542, the inference manager 520 may allocate the second tensor data B to each of the GPU card 1 and the GPU card 2 based on resource margins of the GPU card 1 and the GPU card 2.

According to the embodiments of the present disclosure, by splicing sub-tensor data corresponding to a same deep learning model into a second tensor data, a data batch size may be increased, so that the batch processing capability of the graphics processor may be effectively utilized, the throughput of the graphics processor may be increased, and the utilization rate of the graphics processor may be improved. Furthermore, it is possible to reduce the number of the deep learning models required to be deployed in the memory of the graphics processor, and thus reduce the resource consumption of the graphics processor. As such, the edge device 500 may be deployed at the edge terminal.

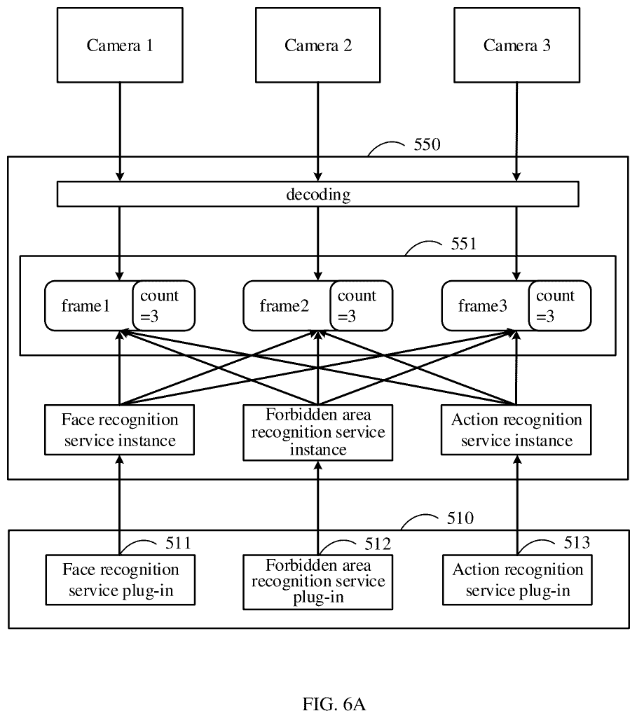

The edge device shown in FIG. 5 is further described below in conjunction with specific embodiments with reference to FIG. 6A, FIG. 6B and FIG. 7 to FIG. 9.

According to the embodiments of the present disclosure, the edge device 500 may further include a frame multiplexer 550. The frame multiplexer 550 may be provided between an external interface of the edge device 500 and the service plug-in manager 510. The external interface of the edge device 500 may be connected to a plurality of cameras, each of which may provide a video stream to the edge device 500. The number of the cameras connected to the external interface of the edge device 500 may be set according to a specific application scenario, which is not limited here. For example, in the application scenario of a park access control system, the park may include 4 entrances, each of which may be provided with 2 cameras, thus the number of the cameras connected to the external interface of the edge device 500 may be 8.

FIG. 6A schematically shows a schematic diagram of a frame multiplexer according to the embodiments of the present disclosure.

As shown in FIG. 6A, the frame multiplexer 550 may be configured to: in response to receiving the video stream, decode the video stream to obtain the video frame data. Specifically, the frame multiplexer 550 may decode a video stream from the camera 1 into a video frame data frame1, decode a video stream from the camera 2 into a video frame data frame2, and decode a video stream from the camera 3 into a video frame data frame3.

According to the embodiments of the present disclosure, the frame multiplexer 550 may be configured to: in response to receiving the video frame data, write the video frame data into a storage unit 551.

According to the embodiments of the present disclosure, the frame multiplexer 550 may be configured to: configure a count field of the video frame data based on a number of at least one dynamic link library. Specifically, the frame multiplexer 550 may be configured to: add the count field for the video frame data; and determine an initial value of the count field based on the number of the at least one dynamic link library. For example, there may be 3 dynamic link libraries, and a count field “count” may be configured for each video frame data respectively. The initial value of each of the count field “count” of the video frame data frame1, the video frame data frame2 and the video frame data frame3 may be set to 3.

According to the embodiments of the present disclosure, the service plug-in manager 510 may generate the service instance based on the configured service plug-ins. For example, the face recognition service plug-in 511 configured by the service plug-in manager 510 may be used to generate a face recognition service instance, the forbidden area recognition service plug-in 512 configured by the service plug-in manager 510 may be used to generate a forbidden area recognition service instance, and the action recognition service plug-in 511 configured by the service plug-in manager 510 may be used to generate an action recognition service instance. The face recognition service instance, the forbidden area recognition service instance and the action recognition service instance may load the video frame data frame1, the video frame data frame2 and the video frame data frame3 from the storage unit, respectively.

According to the embodiments of the present disclosure, the frame multiplexer 550 may be configured to: update the value of the count field of the video frame data in response to detecting that a service instance loads a video frame data from the storage unit; and release the video frame data from the storage unit when the value of the count field of the video frame data reaches a preset value.

FIG. 6B schematically shows a schematic diagram of a workflow of reusing a video frame by a frame multiplexer according to the embodiments of the present disclosure.

As shown in FIG. 6B, the video stream collected by the camera may enter the frame multiplexer 550 through the gateway. After the frame multiplexer 550 decodes the video stream, a video frame data may be obtained. The frame multiplexer 550 may store the video frame data in the memory and generate a data structure corresponding to the video frame data in the memory. The data structure may include two parts, one of which includes a memory address and a reference count field refcounter of the video frame data, and the other part is the memory data of the video frame data. The service instance generated by the service plug-in manager 510 may call the data structure, and find the reference count field refcounter and the memory address of the video frame data based on the data structure. Based on the memory address, the service plug-in manager 510 may achieve the call and processing of the video frame data. Specifically, each service instance may achieve the call of the video frame data through a separate thread. For example, a service instance 1 calls frame1 through a thread 1, and a service instance 2 calls frame1 through a thread 2. After detecting that the service plug-in manager 510 has completed the call of the video frame data, the frame multiplexer 550 may reduce the value of the reference count field refcounter in the data structure by 1. When the value of the reference count field refcounter is less than 1, the frame multiplexer 510 may recycle the data structure, that is, the video frame data is deleted from the memory.

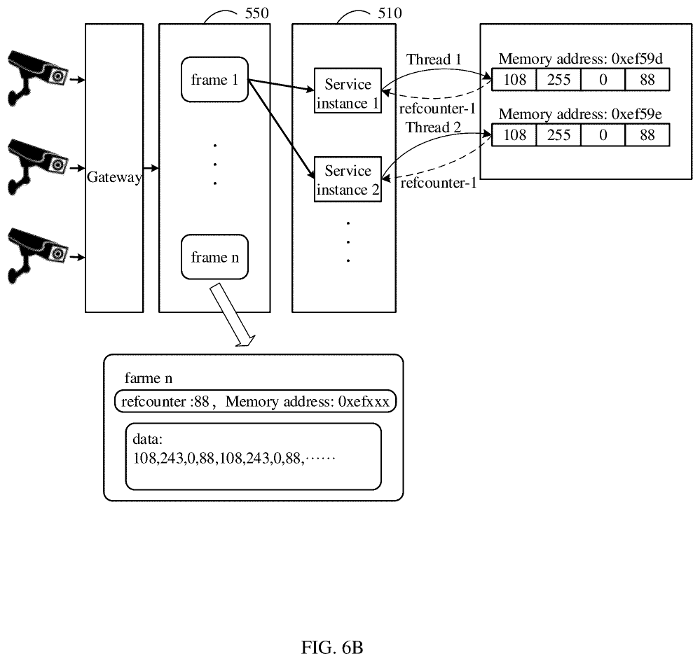

FIG. 7 schematically shows a schematic diagram of a service plug-in manager according to the embodiments of the present disclosure.

As shown in FIG. 7, the service plug-in manager 510 may be configured with a plurality of service interfaces, and by calling a service interface, the service instance may be processed using a method corresponding to the service interface. The plurality of service interfaces may include an init interface, a stop interface, a start interface, a pause interface, a resume interface, and the like. For example, when the stop interface is called, the service instance may be controlled to stop running. For another example, when the start interface is called again, the service instance may be controlled to start running.

According to the embodiments of the present disclosure, the service plug-in manager 510 may manage a plurality of service plug-ins, which may include a face recognition service plug-in 511, a forbidden area recognition service plug-in 512, an action recognition service plug-in 513, etc. Each service plug-in may be represented as a loaded dynamic link library.

According to the embodiments of the present disclosure, the service plug-in manager 510 may be configured to: for each of the plurality of video frame data received within the preset time window, based on at least one loaded dynamic link library, convert the video frame data into at least one first tensor data; and based on at least one first tensor data obtained by converting each of the plurality of video frame data, obtain the plurality of first tensor data. Specifically, each dynamic link library may be associated with at least one target deep learning model, which is from the plurality of deep learning models.

According to the embodiments of the present disclosure, the service plug-in manager 510 may be specifically configured to: in response to receiving the video frame data, based on the at least one dynamic link library, generate at least one service instance; run the at least one service instance, where the at least one service instance is configured to load the video frame data, and process the video frame data based on an input interface standard of each of the at least one target deep learning model associated with the service instance, so as to obtain at least one sub-tensor data; and based on the at least one sub-tensor data respectively corresponding to the at least one service instance, obtain the at least one first tensor data. Specifically, the video frame data may be loaded from the storage unit 551.

According to the embodiments of the present disclosure, in the service plug-in manager 510, a mapping table for each dynamic link library may be maintained, and the mapping table may include at least one deep learning model associated with the dynamic link library and an input interface standard of the at least one deep learning model. When running the service instance, for each video frame data, the service instance may be configured to process the video frame data based on the input interface standard of the at least one deep learning model in the mapping table, so as to obtain at least one sub-tensor data, and the at least one sub-tensor data may be spliced to obtain the first tensor data.

According to the embodiments of the present disclosure, the service instance may be represented as an executable program generated based on a service plug-in. The service instance may be run in a thread of the service plug-in manager 510. After the service instance is run, the service instance may be released from the thread of the service plug-in manager 510.

For example, for the video frame data frame1, the video frame data frame2 and the video frame data frame3, the service plug-in manager 510 may generate a face recognition service instance 1, a face recognition service instance 2 and a face recognition service instance 3 which correspond to the face recognition service plug-in, a forbidden area recognition service instance 1, a forbidden area recognition service instance 2 and a forbidden area recognition service instance 3 which correspond to the forbidden area recognition service plug-in, and an action recognition service instance 1, an action recognition service instance 2 and an action recognition service instance 3 which correspond to the action recognition service plug-in.

According to the embodiments of the present disclosure, the service plug-in manager 510 and the frame multiplexer 550 may be configured to be provided in a CPU device of the edge device, and the inference manager 520, the model manager 530 and the graphics processor 540 may be configured to be provided in a GPU device of the edge device. The communication between the CPU device and the GPU device may be in the form of a request message.

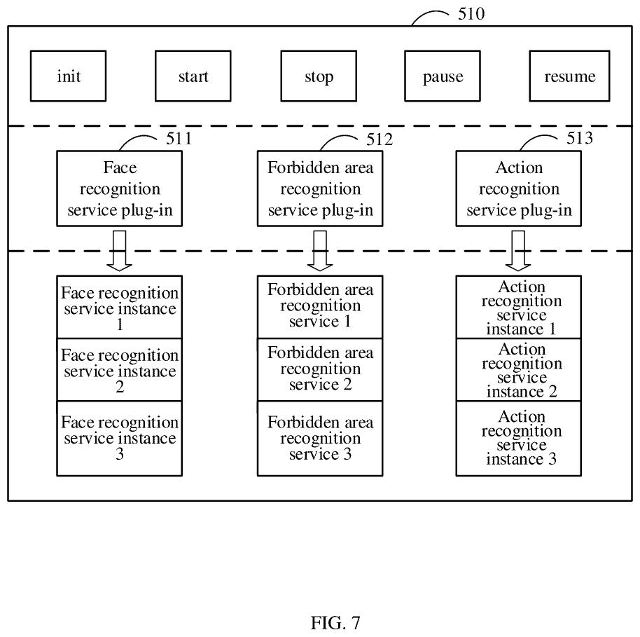

FIG. 8 schematically shows a schematic diagram of a communication process between a service plug-in manager and an inference manager according to the embodiments of the present disclosure.

As shown in FIG. 8, with the time as the axis, the preset time window may include a plurality of sub-windows, and in each sub-window, the service plug-in manager 510 may package all the first tensor data generated within the sub-window into a request.

For example, in a sub-window 1, only the face recognition service instance 1 in the service plug-in manager 510 has been run, then the service plug-in manager 510 may package the first tensor data output by the face recognition service instance 1 into a request req1. In a sub-window 2, the face recognition service instance 2 and the face recognition service instance 3 in the service plug-in manager 510 have been run, then the service plug-in manager 510 may package the first tensor data output by the face recognition service instance 2 and by the face recognition service instance 3 into a request req2. In a sub-window 3, the forbidden area identification service instance 1, the forbidden area identification service instance 2, the forbidden area identification service instance 3, the action recognition service instance 1, the action recognition service instance 2 and the action recognition service instance 3 in the service plug-in manager 510 have all been run, then the service plug-in manager 510 may package the first tensor data output by all of the forbidden area identification service instance 1, the forbidden area identification service instance 2, the forbidden area identification service instance 3, the action recognition service instance 1, the action recognition service instance 2 and the action recognition service instance 3 into a request req3.

According to the embodiments of the present disclosure, the inference manager 520 may be configured to: for requests generated in each sub-window of the preset time window, classify the plurality of sub-tensor data in each request with the deep learning models as a dimension. Each sub-tensor data may carry a model label, and the deep learning model associated with this sub-tensor data may be determined through the model label, thereby completing the classification of the sub-tensor data. More than one sub-tensor data in each category may be suitable for processing by a single deep learning model. The more than one sub-tensor data in each category may be spliced to obtain a second tensor data. That is, the second tensor data obtained after the classification may be processed using a single deep learning model.

For example, a plurality of sub-tensor data in the request req1 may be respectively classified into a second tensor data batch1 and a second tensor data batch3. A plurality of sub-tensor data in the request req2 may be respectively classified into the second tensor data batch1 and the second tensor data batch3. A plurality of sub-tensor data in the request req3 may be respectively classified into the second tensor data batch2 and the second tensor data batch3.

According to the embodiments of the present disclosure, the inference manager 520 may be configured to: for each second tensor data, based on a deep learning model corresponding to the second tensor data and the deep learning models respectively deployed by the plurality of graphics processing units, determine at least one target graphics processing unit from the plurality of graphics processing units, where a deep learning model deployed by the at least one target graphics processing unit includes the deep learning model corresponding to the second tensor data; and allocate the second tensor data to the at least one target graphics processing unit. Specifically, the inference manager 520 may be configured to: segment, based on a resource margin of the at least one target graphics processing unit, the second tensor data with the sub-tensor data as a granularity to obtain at least one sub-data; and respectively allocate the at least one sub-data to the at least one target graphics processing unit.

For example, the inference manager 520 may be configured to allocate the second tensor data batch1 to the GPU card 1, the second tensor data batch2 to the GPU card 2, and the second tensor data batch3 to the GPU cards 3 and 4.

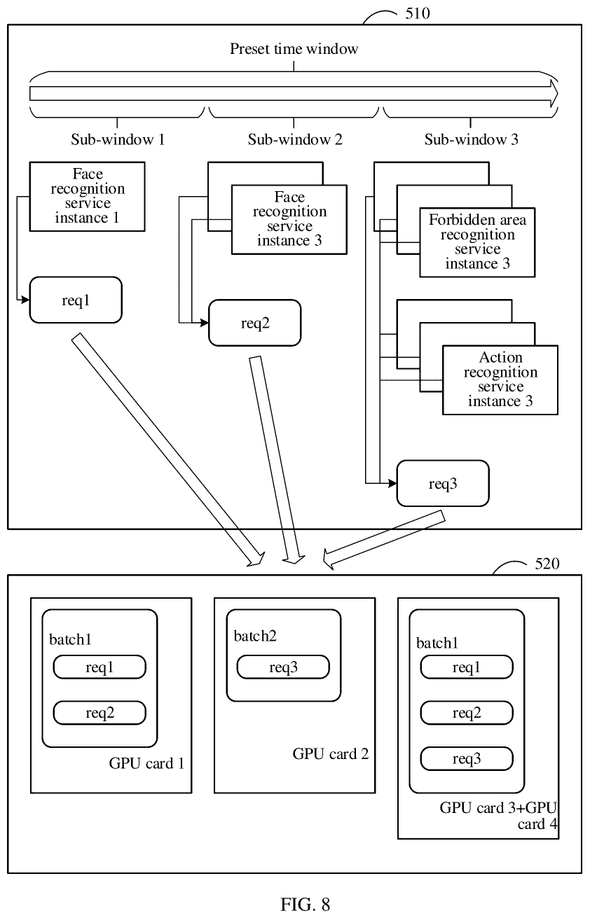

FIG. 9 schematically shows a schematic diagram of a model manager according to the embodiments of the present disclosure.

As shown in FIG. 9, the model manager 530 may be used to manage the deep learning models and deploy the deep learning models in the respective graphics processing units in the graphics processor. After a deep learning model is deployed in a graphics processing unit, the graphics processing unit may generate an instance corresponding to the deep learning model. After receiving the second tensor data, the graphics processing unit may run the instance corresponding to the deep learning model in a thread of the image processing unit, so as to perform data inference on the second tensor data.

For example, four deep learning models, namely, the restrict deep learning model, the motion deep learning model, the mask deep learning model and the quality deep learning model, may be deployed in the graphics processing unit GPU1. After the deep learning models are deployed, the graphics processing unit GPU1 may generate: instances instance1 and instance2 for the restrict model, instances instance1 and instance2 for the motion model, instances instance1 and instance2 for the mask model, and instances instance1 and instance2 for the quality model. The second tensor data may be, for example, data required to be processed by the motion model. After the second tensor data is input into the graphics processing unit GPU1, two threads of the graphics processing unit GPU1 corresponding to the instances instance1 and instance2 for the motion model may respectively load the second tensor data and run a method of the motion model to process the second tensor data.

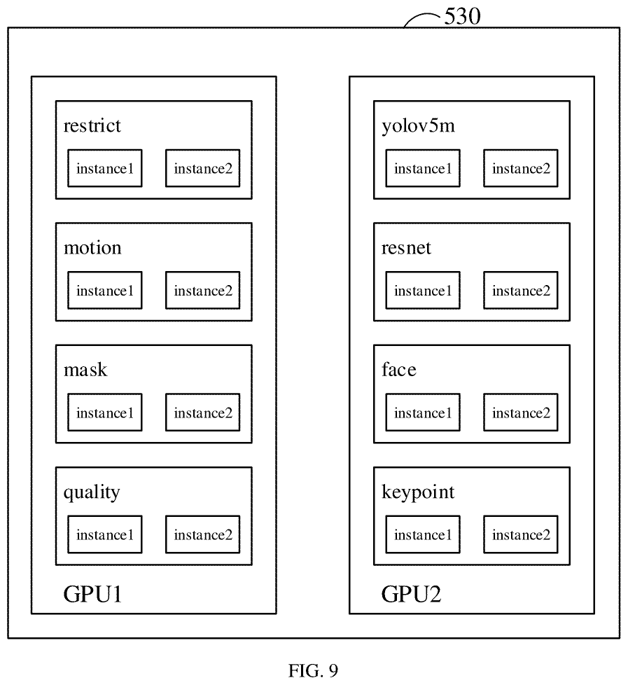

FIG. 10 schematically shows a block diagram of a video processing apparatus according to the embodiments of the present disclosure.

As shown in FIG. 10, a video processing apparatus 1000 may include a first processing module 1010, a second processing module 1020, and an allocation module 1030.

The first processing module 1010 is configured to: obtain a plurality of first tensor data based on a plurality of video frame data received within a preset time window, where the plurality of first tensor data includes a plurality of sub-tensor data each corresponding to a respective one of a plurality of deep learning models.

The second processing module 1020 is configured to: splice the plurality of sub-tensor data in the plurality of first tensor data to obtain a plurality of second tensor data each corresponding to a respective one of the plurality of deep learning models.

The allocation module 1030 is configured to: allocate the plurality of second tensor data to a plurality of graphics processing units in a graphics processor, based on at least one of the deep learning models respectively deployed by the plurality of graphics processing units, such that the graphics processor performs data inference on the plurality of second tensor data.

According to the embodiments of the present disclosure, the video processing apparatus 1000 may further include a conversion module and a third processing module.

The conversion module is configured to: for each of the plurality of video frame data received within the preset time window, convert the video frame data into at least one first tensor data based on at least one dynamic link library loaded.

The third processing module is configured to: obtain the plurality of first tensor data based on at least one first tensor data obtained by converting each of the plurality of video frame data.

According to the embodiments of the present disclosure, the dynamic link library is associated with at least one target deep learning model from the plurality of deep learning models.

According to the embodiments of the present disclosure, the conversion module includes a first conversion unit, a second conversion unit, and a third conversion unit.

The first conversion unit is configured to: for each video frame data, generate at least one service instance based on the at least one dynamic link library.

The second conversion unit is configured to: run at least one service instance, where the at least one service instance is configured to load the video frame data, and process the video frame data based on the input interface standard of each of the at least one target deep learning model associated with the service instance to obtain at least one sub-tensor data.

The third conversion unit is configured to: obtain the at least one first tensor data based on the at least one sub-tensor data respectively corresponding to the at least one service instance.

According to the embodiments of the present disclosure, the video processing apparatus 1000 may further include a writing module.

The writing module is configured to: in response to receiving the video frame data, write the video frame data into a storage unit.

According to the embodiments of the present disclosure, the service instance is configured to load the video frame data from the storage unit.

According to the embodiments of the present disclosure, the video processing apparatus 1000 may further include a configuration module, an update module and a release module.

The configuration module is configured to configure a count field of the video frame data based on a number of the at least one dynamic link library.

The update module is configured to update a value of the count field of the video frame data in response to detecting that a service instance loads the video frame data from the storage unit.

The release module is configured to release the video frame data from the storage unit in response to the value of the count field of the video frame data reaching a preset value.

According to the embodiments of the present disclosure, the configuration module includes a first configuration unit and a second configuration unit.

The first configuration unit is configured to add the count field for the video frame data.

The second configuration unit is configured to determine an initial value of the count field based on the number of the at least one dynamic link library.

According to the embodiments of the present disclosure, the allocation module 1030 includes a first allocation unit and a second allocation unit.

The first allocation unit is configured to: for each second tensor data, based on a deep learning model corresponding to the second tensor data and the deep learning models respectively deployed by the plurality of graphics processing units, determine at least one target graphics processing unit from the plurality of graphics processing units, where a deep learning model deployed by the at least one target graphics processing unit includes the deep learning model corresponding to the second tensor data.

The second allocation unit is configured to allocate the second tensor data to the at least one target graphics processing unit.

According to the embodiments of the present disclosure, the second allocation unit includes a first allocation sub-unit and a second allocation sub-unit.

The first allocation sub-unit is configured to: segment, based on a resource margin of the at least one target graphics processing unit, the second tensor data with the sub-tensor data as a granularity to obtain the at least one sub-data.

The second allocation sub-unit is configured to allocate the at least one sub-data to at least one target graphics processing unit.

According to the embodiments of the present disclosure, the video processing apparatus 1000 may further include a decoding module.

The decoding module is configured to: in response to receiving a video stream, decode the video stream to obtain the plurality of video frame data.

According to the embodiments of the present invention, any one or more of the modules, sub-modules, units, and sub-units, or at least part of the functions of any one of them, may be implemented in one module. According to the embodiments of the present invention, any one or more of the modules, sub-modules, units and sub-units may be split into a plurality of modules for implementation. According to the embodiments of the present invention, any one or more of the modules, sub-modules, units, and sub-units may be at least partially implemented as hardware circuits, such as field programmable gate arrays (FPGA), programmable logic arrays (PLA), systems on chips, systems on substrates, systems on packages, application specific integrated circuits (ASIC), or may be implemented by hardware or firmware in any other reasonable way of integrating or packaging circuits, or may be implemented in any one of the three implementation methods of software, hardware, and firmware, or in any appropriate combination of any of them. Alternatively, according to the embodiments of the present invention, one or more of the modules, sub-modules, units and sub-units may be at least partially implemented as computer program modules, and when the computer program modules are executed, corresponding functions may be performed.

For example, any of the first processing module 1010, the second processing module 1020, and the allocation module 1030 may be combined in one module/unit/sub-unit, or any of the modules/units/sub-units may be split into plurality of modules/units/sub-units. Alternatively, at least part of the functions of one or more of these modules/units/sub-units may be combined with at least part of the functions of other modules/units/sub-units and implemented in one module/unit/sub-unit. According to the embodiments of the present disclosure, at least one of the first processing module 1010, the second processing module 1020 or the allocation module 1030 may be at least partially implemented as a hardware circuit, such as a field programmable gate array (FPGA), a programmable logic array (PLA), a system on a chip, a system on a substrate, a system on a package, an application specific integrated circuit (ASIC), or may be implemented by hardware or firmware such as any other reasonable way of integrating or packaging the circuit, or implemented in any one of the three implementation methods of software, hardware and firmware, or in a suitable combination of any of them. Alternatively, at least one of the first processing module 1010, the second processing module 1020, and the allocation module 1030 may be at least partially implemented as a computer program module, and when the computer program module is executed, corresponding functions may be performed.

It should be noted that the section of the video data processing apparatus in the embodiments of the present disclosure corresponds to the section of the video data processing method in the embodiments of the present disclosure. For the description of the video data processing apparatus, specific reference may be made to the section of the video data processing method, which will not be repeated here.

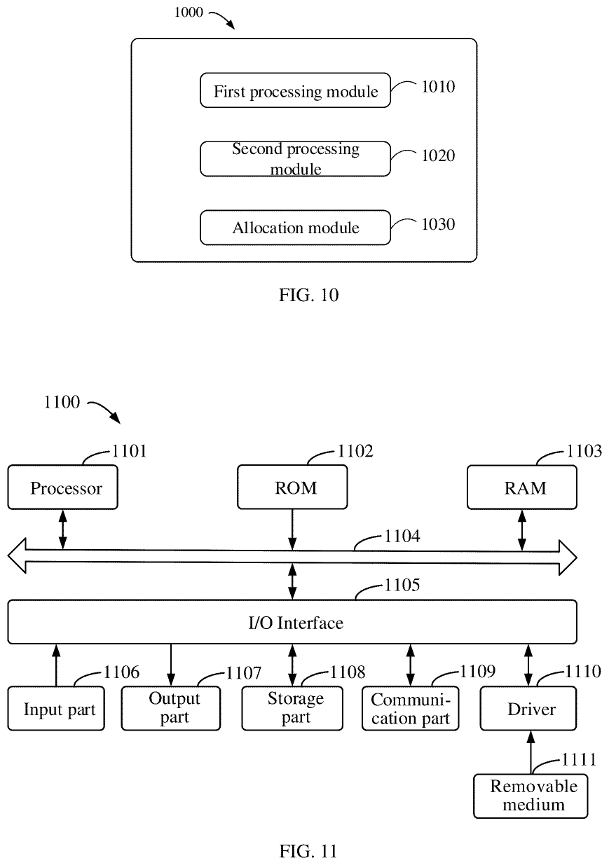

FIG. 11 schematically shows a block diagram of an electronic device suitable for implementing a video data processing method according to the embodiments of the present disclosure. The electronic device shown in FIG. 11 is merely an example and should not limit the functions and scope of use of the embodiments of the present disclosure.

As shown in FIG. 11, an electronic device 1100 according to the embodiments of the present disclosure includes a processor 1101, which may perform various appropriate operations and processes based on a program stored in a read-only memory (ROM) 1102 or a program loaded from a storage portion 1108 to a random-access memory (RAM) 1103. The processor 1101 may include, for example, a general-purpose microprocessor (e.g., a CPU), an instruction set processor and/or a related chip set and/or a special-purpose microprocessor (e.g., an application-specific integrated circuit (ASIC)), etc. The processor 1101 may further include an on-board memory for caching. The processor 1101 may include a single processing unit or a plurality of processing units for performing different operations of the method flow according to the embodiments of the present disclosure.

In the RAM 1103, various programs and data necessary for operations of the electronic device 1100 are stored. The processor 1101, the ROM 1102 and the RAM 1103 are connected to each other via a bus 1104. The processor 1101 performs various operations of the method flow according to the embodiments of the present disclosure by executing the program in the ROM 1102 and/or the RAM 1103. It will be noted that the program may also be stored in one or more memories other than the ROM 1102 and the RAM 1103. The processor 1101 may also perform the various operations of the method flow according to the embodiments of the present disclosure by executing program(s) stored in the one or more memories.

According to the embodiments of the present disclosure, the electronic device 1100 may further include an input/output (I/O) interface 1105, which is also connected to the bus 1104. The electronic device 1100 may further include one or more of the following components connected to the input/output (I/O) interface 1105: an input part 1106 including a keyboard, a mouse, etc.; an output part 1107 including a cathode ray tube (CRT), a liquid crystal display (LCD), a speaker, etc.; a storage part 1108 including a hard disk, etc.; and a communication part 1109 including a network interface card such as a LAN card, a modem, etc. The communication part 1109 performs communication processing via a network such as the Internet. A driver 1110 is also connected to the input/output (I/O) interface 1105 as desired. A removable medium 1111, such as a magnetic disk, an optical disk, a magneto-optical disk, a semiconductor memory or the like, is mounted on the driver 1110 as desired, so that a computer program read therefrom is installed into the storage portion 1108 as desired.

The present disclosure further provides a non-transitory computer-readable storage medium, which may be in the device/apparatus/system described in the above embodiments; or may exist independently without being assembled into the device/apparatus/system. The computer-readable storage medium carries one or more programs, which when executed, implement the method according to the embodiments of the present disclosure.

According to the embodiments of the present disclosure, the computer-readable storage medium may be a non-volatile computer-readable storage medium, for example, may include but is not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, a computer readable storage medium may be any tangible medium that may contain or store a program for use by or in connection with an instruction execution system, apparatus, or device. For example, according to the embodiments of the present disclosure, the computer-readable storage medium may include the ROM 1102 and/or the RAM 1103 described above and/or one or more memories other than the ROM 1102 and the RAM 1103.

The embodiment of the present disclosure further includes a computer program product, which includes a computer program, and the computer program contains program codes for executing the method shown in the flowchart. When the computer program product is executed in a computer system, the program code is used to cause the computer system to implement the verification method of the process data of the product provided in the embodiments of the present disclosure.

When the computer program is executed by the processor 1101, the above functions defined in the system/device of the embodiment of the present disclosure are performed. According to the embodiments of the present disclosure, the systems, devices, modules, units, etc. described above may be implemented by computer program modules.

In an embodiment, the computer program may rely on tangible storage media such as optical storage devices and magnetic storage devices. In another embodiment, the computer program may also be transmitted and distributed in the form of signals on a network medium, and downloaded and installed through the communication part 1109, and/or installed from a removable medium 1111. The program code contained in the computer program may be transmitted using any appropriate network medium, including but not limited to: a wireless one, a wired one, etc., or any suitable combination of the above.

In such embodiment, the computer program may be downloaded and installed from the network through the communication part 1109, and/or installed from the removable medium 1111. When the computer program is executed by the processor 1101, the above functions defined in the system of the embodiments of the present disclosure are performed. According to the embodiments of the present disclosure, the systems, devices, devices, modules, units, etc. described above may be implemented by computer program modules.

According to the embodiments of the present disclosure, the program codes for executing the computer program provided in the embodiments of the present disclosure may be written in any combination of one or more programming languages. Specifically, these computer programs may be implemented using a high-level procedural and/or object-oriented programming language, and/or an assembly/machine language. The programming language includes but are not limited to programming languages such as Java, C++, Python, “C” language, or similar programming languages. The program codes may be executed entirely on a user computing device, partially on a user device, partially on a remote computing device, or entirely on a remote computing device or a server. In the case of a remote computing device, the remote computing device may be connected to the user computing device through any type of network, including a local area network (LAN) or a wide area network (WAN), or may be connected to an external computing device (e.g., through the Internet using an Internet service provider).

The flowcharts and block diagrams in the accompanying drawings illustrate possible architectures, functions and operations of the systems, methods and computer program products according to the various embodiments of the present disclosure. In this regard, each block in the flowchart or the block diagram may represent a module, a program segment or a part of codes, which contains one or more executable instructions for implementing the specified logical functions. It should also be noted that in some alternative implementations, the functions marked in the box may also occur in a different order than that marked in the accompanying drawings. For example, two boxes represented in succession may actually be executed substantially in parallel, and they may sometimes be executed in reverse order, depending on the functions involved. It should also be noted that each block in the block diagrams or flowcharts, and combinations of blocks in the block diagrams or flowcharts, may be implemented by a dedicated hardware-based system that performs the specified functions or operations, or may be implemented by a combination of dedicated hardware and computer instructions.

Those skilled in the art will appreciate that the features described in the various embodiments and/or claims of the present disclosure may be combined and/or integrated in various ways, even if such combinations or integrations are not explicitly described in the present disclosure. In particular, various combinations and/or integrations of features recited in the various embodiments and/or claims of the present disclosure may be made without departing from the spirit and teachings of the present disclosure. All such combinations and/or integrations fall within the scope of the present disclosure.

The embodiments of the present disclosure are described above. However, these embodiments are for illustrative purposes only and are not intended to limit the scope of the present disclosure. Although the various embodiments are described above separately, this does not mean that measures in the various embodiments cannot be used in combination advantageously. The scope of the present disclosure is defined in accordance with the appended claims and their equivalents. Without departing from the scope of the present disclosure, those skilled in the art may make various substitutions and modifications, all of which should fall within the scope of the present disclosure.

1. A video data processing method, comprising:
obtaining a plurality of first tensor data based on a plurality of video frame data received within a preset time window, wherein the plurality of first tensor data comprises a plurality of sub-tensor data each corresponding to a respective one of a plurality of deep learning models;
splicing the plurality of sub-tensor data in the plurality of first tensor data to obtain a plurality of second tensor data each corresponding to a respective one of the plurality of deep learning models; and
allocating the plurality of second tensor data to a plurality of graphics processing units in a graphics processor respectively, based on the plurality of deep learning models respectively deployed by the plurality of graphics processing units, such that the graphics processor performs data inference on the plurality of second tensor data.

2. The method of claim 1, wherein the obtaining a plurality of first tensor data based on a plurality of video frame data received within a preset time window comprises:
for each of the plurality of video frame data received within the preset time window, converting the video frame data into at least one first tensor data based on at least one dynamic link library loaded; and
obtaining the plurality of first tensor data based on at least one first tensor data obtained by converting each of the plurality of video frame data.

3. The method of claim 2, wherein the at least one dynamic link library is associated with at least one target deep learning model from the plurality of deep learning models,
wherein the for each of the plurality of video frame data received within the preset time window, converting the video frame data into at least one first tensor data based on at least one dynamic link library loaded comprises:
for each video frame data, generating at least one service instance based on the at least one dynamic link library;
running the at least one service instance, wherein the at least one service instance is configured to load the video frame data, and processing the video frame data based on an input interface standard of each of the at least one target deep learning model associated with the at least one service instance, so as to obtain at least one sub-tensor data; and
obtaining the at least one first tensor data based on the at least one sub-tensor data respectively corresponding to the at least one service instance.

4. The method of claim 3, further comprising:
in response to receiving the video frame data, writing the video frame data into a storage unit,
wherein the at least one service instance is configured to load the video frame data from the storage unit.

5. The method of claim 4, further comprising:
configuring a count field of the video frame data based on a number of the at least one dynamic link library;
updating a value of the count field of the video frame data in response to detecting that a service instance loads the video frame data from the storage unit; and
releasing the video frame data from the storage unit in response to the value of the count field of the video frame data reaching a preset value.

6. The method of claim 5, wherein the configuring a count field of the video frame data based on a number of the at least one dynamic link library comprises:
adding the count field for the video frame data; and
determining an initial value of the count field based on the number of the at least one dynamic link library.

7. The method of claim 1, wherein the allocating the plurality of second tensor data to a plurality of graphics processing units in a graphics processor respectively based on the plurality of deep learning models respectively deployed by the plurality of graphics processing units comprises:
for each second tensor data, based on a deep learning model corresponding to the second tensor data and the plurality of deep learning models respectively deployed by the plurality of graphics processing units, determining at least one target graphics processing unit from the plurality of graphics processing units, wherein a deep learning model deployed by the at least one target graphics processing unit comprises the deep learning model corresponding to the second tensor data; and
allocating the second tensor data to the at least one target graphics processing unit.

8. The method of claim 7, wherein the allocating the second tensor data to the at least one target graphics processing unit comprises:
segmenting, based on a resource margin of the at least one target graphics processing unit, the second tensor data with the sub-tensor data as a granularity to obtain at least one sub-data; and
allocating the at least one sub-data to the at least one target graphics processing unit.

9. The method of claim 1, further comprising:
in response to receiving a video stream, decoding the video stream to obtain the plurality of video frame data.

10. (canceled)

11. An electronic device, comprising a memory and a processor, wherein the memory stores instructions executable by the processor, and the instructions, when executed by the processor, cause the processor to perform the method of claim 1.

12. A non-transitory computer-readable storage medium, storing computer instructions configured to cause a computer to perform the method of claim 1.

13. (canceled)

14. An edge device, comprising:
a service plug-in manager, an inference manager and a model manager,
wherein the service plug-in manager is configured to:
obtain a plurality of first tensor data based on a plurality of video frame data received within a preset time window, wherein the plurality of first tensor data comprises a plurality of sub-tensor data each corresponding to a respective one of a plurality of deep learning models;
the inference manager is configured to:
splice the plurality of sub-tensor data in the plurality of first tensor data to obtain a plurality of second tensor data each corresponding to a respective one of the plurality of deep learning models; and
allocate the plurality of second tensor data to a plurality of graphics processing units in a graphics processor respectively, based on the plurality of deep learning models respectively deployed by the plurality of graphics processing units; and
the model manager is configured to:
perform data inference on the plurality of second tensor data using the graphics processor.

15. The edge device of claim 14, wherein the service plug-in manager is configured to:
for each of the plurality of video frame data received within the preset time window, convert the video frame data into at least one first tensor data based on at least one dynamic link library loaded; and
obtain the plurality of first tensor data based on at least one first tensor data obtained by converting each of the plurality of video frame data.

16. The edge device of claim 15, wherein the at least one dynamic link library is associated with at least one target deep learning model from the plurality of deep learning models,
wherein the service plug-in manager is configured to:
in response to receiving the video frame data, generate at least one service instance based on the at least one dynamic link library;
run the at least one service instance, wherein the at least one service instance is configured to load the video frame data, and process the video frame data based on an input interface standard of each of the at least one target deep learning model associated with the at least one service instance, so as to obtain at least one sub-tensor data; and
obtain the at least one first tensor data based on the at least one sub-tensor data respectively corresponding to the at least one service instance.

17. The edge device of claim 16, wherein the edge device further comprises a frame multiplexer configured to:
in response to receiving the video frame data, write the video frame data into a storage unit,
wherein the service plug-in manager is configured to:
load the video frame data from the storage unit using the at least one service instance.

18. The edge device of claim 17, wherein the frame multiplexer is configured to:
configure a count field of the video frame data based on a number of the at least one dynamic link library;
update a value of the count field of the video frame data in response to detecting that a service instance loads the video frame data from the storage unit; and
release the video frame data from the storage unit in response to the value of the count field of the video frame data reaching a preset value.

19. The edge device of claim 18, wherein the frame multiplexer is configured to:
add the count field for the video frame data; and
determine an initial value of the count field based on the number of the at least one dynamic link library.

20. The edge device of claim 14, wherein the inference manager is configured to:
for each second tensor data, based on a deep learning model corresponding to the second tensor data and the plurality of deep learning models respectively deployed by the plurality of graphics processing units, determine at least one target graphics processing unit from the plurality of graphics processing units, wherein a deep learning model deployed by the at least one target graphics processing unit comprises the deep learning model corresponding to the second tensor data; and
allocate the second tensor data to the at least one target graphics processing unit.

21. The edge device of claim 20, wherein the inference manager is configured to:
segment, based on a resource margin of the at least one target graphics processing unit, the second tensor data with the sub-tensor data as a granularity to obtain the at least one sub-data; and
allocating the at least one sub-data to the at least one target graphics processing unit.

22. The edge device of claim 14, wherein the service plug-in manager is configured to:
in response to receiving a video stream, decode the video stream to obtain the video frame data.
